(19) United States
(12) Patent Application Publication
(10) Pub. No.: US 2008/0038447 A1
(43) Pub. Date: Feb. 14, 2008

(54) FABRICATING METHOD OF ELECTRODE ADHESIVE BICELL

(76) Inventor: Yu-Ta Tu, Hsinchu Hsieh (TW)

Correspondence Address: YU-TA TU, 235 Chung - Ho, Box 8-24, Taipei, TW

(21) Appl. No.: 11/874,904

(22) Filed: Oct. 19, 2007

Related U.S. Application Data
(63) Continuation of application No. 11/187,641, filed on Jul. 21, 2005, now abandoned.

(51) Int. Cl. B05D 5/12

(52) U.S. Cl. 427/58

(57) ABSTRACT

A method for manufacturing an electrode adhesive bicell comprises steps of forming a solid state positive electrode film; forming a solid state negative electrode film; mixing polymer adhesive, a filler and two solvents of different boiling points as a mixing material; the mixing material being coated upon two opposite surfaces of a porous membrane as a coated object; the coated object being then dried as a separator membrane; the two solvents of different boiling points serving to solving the polymer adhesive, after the solvent of lower boiling point is evaporated, the other solvent of high boiling point is retained so that the separator membrane is retained as a gel with good adhesive and plasticity for the combination of solid state positive electrode film and solid state negative electrode film.

The present invention is a continuation in part of U.S. patent application Ser. No. 11/187,641 which is assigned to and invented by the inventor and applicant of the present invention. Thus, the content of U.S. patent application Ser. No. 11/1187,641 is incorporated into the present invention as a part of the present invention.

### FIELD OF THE INVENTION

The present invention relates to cell, and particularly to a method for manufacturing an electrode adhesive bicell, wherein the cell has no defect of the prior art cell and has preferred adhesive and plasticity. The properties of the cell are improved, and no plasticizer (such as DBP) is used. Advantages of the cell are that the manufacturing time is short. The cell is safe, high energy density, long lifetime, low internal impedance, matched to the requirement of environmental protection, and can provides larger power.

### BACKGROUND OF THE INVENTION

A large amount of higher performance and lower cost secondary cells are required because various portable electronic products such as cellular phones, notebook computers, personal digital assistances (PDAs), etc., are developed. Lithium polymer most conforms to the above-mentioned requirements since it has the advantage of high energy density, long circulation times, high operation voltage, long storage life, as well as it is very safe upon using said cells.

In some prior art, such as U.S. Pat. No. 5,540,741 that utilizes poly vinylidene fluoride and hexa fluoropropylene as the binding agent. Further, they add di-butyl phthalate (DBP) as plasticizers for film-formation of the slurry of positive and negative electrode and the film-formation of films such that the polar plate of positive and negative charge and the films could be separated from a substrate after coating which also let the rear end electrode material is processed through heat-pressing with the electrode separator membrane & the electronic-collecting net. After they were unified into bicell, it extracts DBP out by utilizing the solvents such as methanol so that there has a purity of pore structure for electrode plate and separator membrane.

The advantage of the above-mentioned fabricating method is mainly on the introduction of plasticizer, which let the electrode material having fine degree of plasticity after coating and thus it could combines the electronic collector, the plate material and the separator membrane, after the plasticizers being taken out, it has the effect of pore-forming, which forms the electrolyte conductor. Besides, since the positive and negative electrode are combined tightly through the separator membrane, the joint is difficult to form voids which interferes with the ion transport, and thus it is unnecessary to get rid of the requirement of tightly pressing the electrode of the outer package such that the cells are lighter and thinner. However, since it took too long to take out DBP, which consumes large amounts of extract solvent, it is easily to be left, which influences the performance of cells. That's its drawback.

### SUMMARY OF THE INVENTION

Accordingly, the primary object of the present invention is to provide a method for manufacturing an electrode adhesive bicell, wherein the cell has no defect of the prior art cell and has preferred adhesive and plasticity. The properties of the cell are improved, and no plasticizer (such as DBP) is used. Advantages of the cell are that the manufacturing time is short. The cell is safe, high energy density, long lifetime, low internal impedance, matched to the requirement of environmental protection, and can provides larger power.

To achieve above objects, the present invention provides a method for manufacturing an electrode adhesive bicell, comprising steps of: (a) forming a solid state positive electrode film; (b) forming a solid state negative electrode film; (c) mixing polymer adhesive, a filler and two solvents of different boiling points as a mixing material; the mixing material being coated upon two opposite surfaces of a porous membrane as a coated object; the coated object being then dried as a separator membrane; the two solvents of different boiling points serving to solving the polymer adhesive; after the solvent of lower boiling point is evaporated, the other solvent of high boiling point is retained so that the separator membrane is retained as a gel with good adhesion and plasticity for the combination of solid state positive electrode film and solid state negative electrode film; and (d) cutting the solid state positive electrode film, the solid state negative electrode film and the separator membrane to have predetermined sizes according to a desired capacity; the separator membrane being clamped between the solid state positive electrode film and the solid state negative electrode film; then, compressing, heat-blowing and drying the combination structure as a bicell; and (e) welding a positive electrode conductive stem and a negative electrode conductive stem to the bicell and then welded bicell being placed into an aluminum film bag for vacuuming and then drying for dewater; then electrolyte is filled into the bag for activating the bicell.

The various objects and advantages of the present invention will be more readily understood from the following detailed description when read in conjunction with the appended drawing.

### BRIEF DESCRIPTION OF THE DRAWINGS

FIG. 1 is a structural view of the cell of the present invention.

FIG. 2 is a perspective view of the cell of the present invention.

FIG. 3 is a structural view about the positive electrode of the cell of the present invention.

FIGS. 4 and 5 are another structural views of the positive electrode of the present invention.

FIG. 6 is a structural view of the negative electrode of the present invention.

FIGS. 7 and 8 are another structural view of the cell of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

The process for manufacturing an electrode adhesive cell according to the present invention comprising the step of:

(1) forming a solid state positive electrode film;

(2) forming a solid state negative electrode film;

(3) mixing polymer adhesive, a filler and two solvents of different boiling points as a mixing material; the mixing material being coated upon two opposite surfaces of a sheet of polyethylene membrane or a sheet of polypropylene membrane as a coated object; the coated object being then dried as a separator membrane; the two solvents of different boiling points serving to solving the polymer adhesive; after the solvent of lower boiling point is evaporated, then the other solvent of high boiling point is retained so that the separator membrane is retained as a gel with good adhesive and plasticity for the combination of the solid state positive electrode film and the solid state negative electrode film.

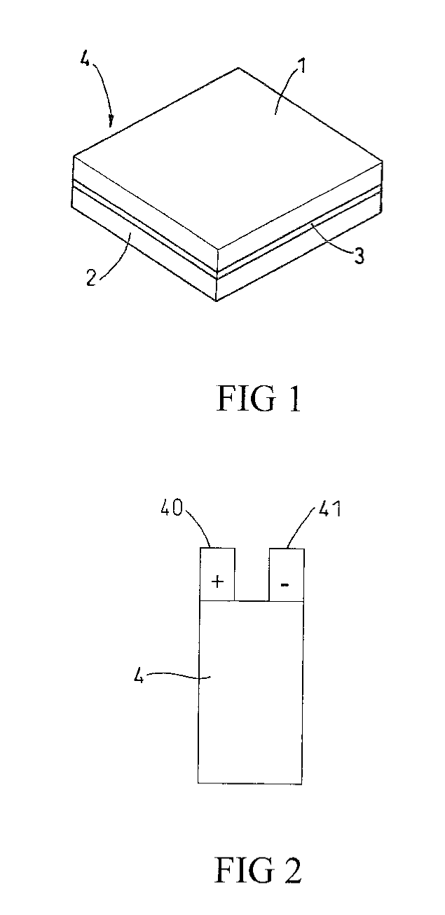

(4) Referring to FIG. 1, cutting the solid state positive electrode film 1, solid state negative electrode film 2 and separator membrane 3 to have predetermined sizes according to a desired capacity. The separator membrane 3 is clamped between the solid state positive electrode film 1 and the solid state negative electrode film 2. Then, compressing, heat-blowing and drying the combination structure as a bicell 4.

(5) Referring to FIG. 2, welding a positive electrode conductive stem 40 and a negative electrode conductive stem 41 to the bicell 4 and then welded bicell 4 being placed into an aluminum film bag for vacuuming and then drying for dewater. Then electrolyte is filled into the bag for activating the bicell 4.

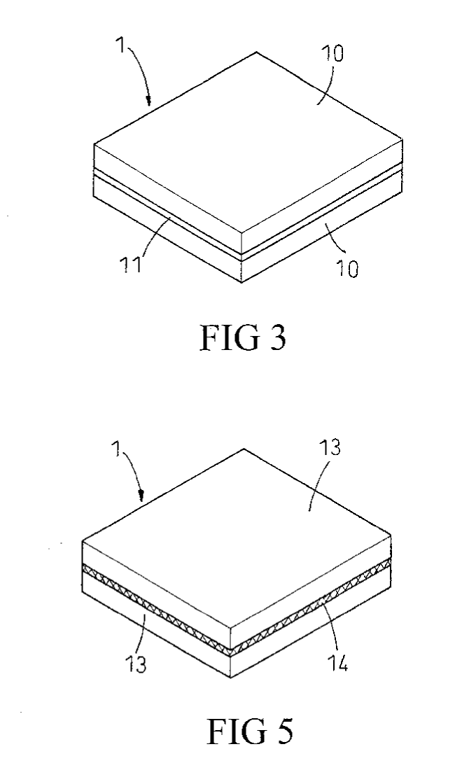

Referring to FIG. 3, in the present invention, the method for forming the solid state positive electrode film 1 includes the step of mixing a polymer adhesive, two solvents of different boiling points, a conductive carbon, an active material into a slurry material 10; and then coating the slurry material 10 at two opposite surfaces of a current collector 11; and then the coated collector 11 being dried so as to form the solid state positive electrode film, wherein the current collector 11 may be an aluminum film. The two solvents of different boiling points serves to solve the polymer adhesive; after the solvent of lower boiling point is evaporated, then the other solvent of high boiling point is retained so that the separator membrane is retained as a gel with good adhesion and plasticity for the combination of current collector.

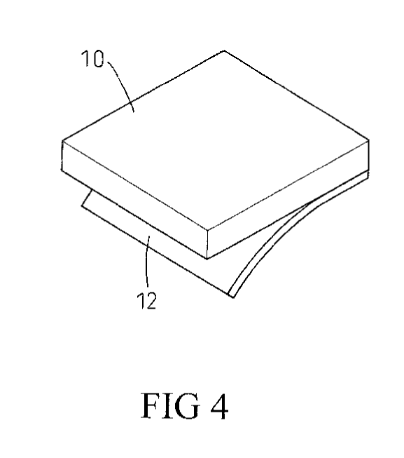

Referring to FIG. 4, in the present invention, the method for forming the solid state positive electrode film 1 includes the step of mixing a polymer adhesive, two solvents of different boiling points, a conductive carbon, an active material into a slurry material 10; and then coating the slurry material 10 at two opposite surfaces of a PET (Polyethylene terephthalate) substrate 12; and then the coated PET substrate 12. The two solvents of different boiling points serves to solve the polymer * adhesive; after the solvent of lower boiling point is evaporated, then the other solvent of high boiling point is retained so that the separator membrane is retained as a gel. After drying, the substrate 12 is taken down, as shown in FIG. 5 as a positive electrode film. Then the positive electrode film is placed into two opposite sides of a netlike current collector 14 as a combining structure. Then the combining structure is heat-compressed as a solid state positive electrode film 1. In this process, the netlike current collector 14 is an aluminum net.

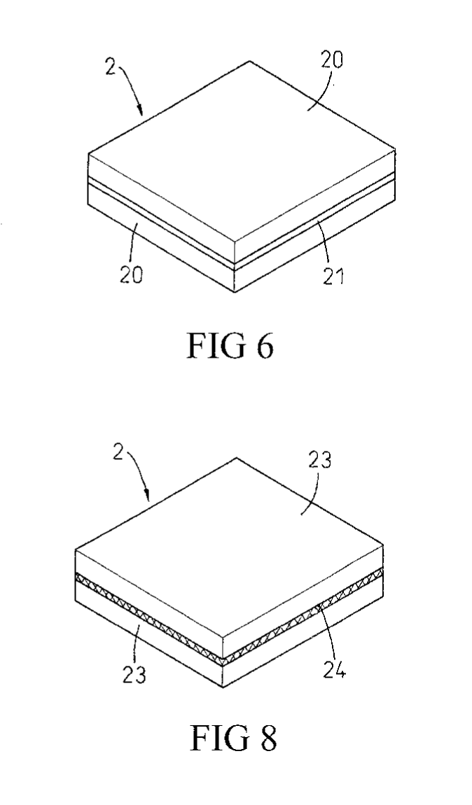

Referring to FIG. 6, in the present invention, the method for forming the solid state negative electrode film 2 includes the step of mixing a polymer adhesive, two solvents of different boiling points, a conductive carbon, an active material into a slurry material 20; and then coating the slurry material 20 at two opposite surfaces of a current collector 21; and then the coated current collector 21 being dried so as to form the solid state negative electrode film, wherein the current collector 21 may be a copper film. The two solvents of different boiling points serves to solve the polymer adhesive; after the solvent of lower boiling point is evaporated, then the other solvent of high boiling point is retained so that the separator membrane is retained as a gel with good adhesion and plasticity for the combination of current collector.

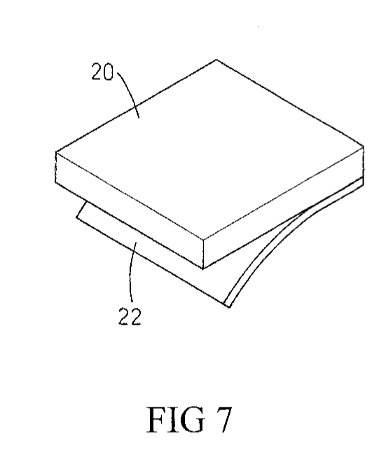

Referring to FIG. 7, in the present invention, the method for forming the solid state negative electrode film includes the step of mixing a polymer adhesive, two solvents of different boiling points, a conductive carbon, an active material into a slurry material 20; and then coating the slurry material 10 at two opposite surfaces of a PET substrate 22; and then the coated PET substrate 12. The two solvents of different boiling points serves to solve the polymer adhesive; after the solvent of lower boiling point is evaporated, then the other solvent of high boiling point is retained so that the separator membrane is retained as a gel. After drying, the substrate 22 is taken down, as shown in FIG. 8 as a positive electrode film. Then the negative electrode film 23 is placed into two opposite sides of a netlike current collector 24 as a combining structure. Then the combining structure is heat-compressed as a solid state negative electrode film 2. In this process, the netlike current collector 24 is a copper net.

A further analysis about the methods for manufacturing the solid state positive electrode film, solid state negative electrode film and separator membrane will be described herein.

(A) Positive Electrode Film

In the present invention, the method for forming the solid state positive electrode film 1 includes the step of mixing and then grinding a polymer adhesive, two solvents of different boiling points (for example acetone and NMP), a conductive carbon, an active material into a positive electrode slurry material 10 wherein the grinding is made by a ball grinding machine through five hours. The polymer adhesive contains poly vinylidene fluoride with a ratio of about 2-15 wt %. The conductive carbon is such as carbon black with a ratio of about 2-10 wt %. The active material is such as LiCoO2, LiNiO2, LiMn2O4, LiNixCo1-xO2 with a ratio of about 75˜96 wt %.

The current collector is a copper foil or a copper net. If aluminum foil is used, the positive electrode slurry material is coated directly upon the aluminum foil by a coating machine. If the aluminum net is used, the positive electrode slurry material is coated upon the PET substrate. After drying, the substrate 12 is taken down as a positive electrode film. Then the positive electrode film is placed into two opposite sides of a netlike current collector 14 as a combining structure. Then the combining structure is heat compressed and cut to have a desired size as a solid state positive electrode film 1.

(B) Negative Electrode Film

In the present invention, the method for forming the solid state negative electrode film 2 includes the step of mixing and then grinding a polymer adhesive, two solvents of different boiling points (for example acetone and NMP), a conductive carbon, an active material into a negative electrode slurry material 20 wherein the grinding is made by a ball grinding machine through five hours. The polymer adhesive contains poly vinylidene fluoride with a ratio of about 2˜15 wt %. The conductive carbon is such as carbon black with a ratio of about 2˜10 wt %. The active substance such as the mesocarbon microbeads, nature graphite as well as its refinement, other carbon material, tin compound, silicide has a content of 75-96 wt %.

The current collector is a copper foil or a copper net. If aluminum foil is used, the negative electrode slurry material is coated directly upon the copper foil by a coating machine. If the copper net is used, the positive electrode slurry material is coated upon the PET substrate. After drying, the substrate 12 is taken down as a negative electrode film. Then the negative electrode film is placed into two opposite sides of a netlike current collector (copper net) as a combining structure. Then the combining structure is heat compressed and cut to have a desired size as a solid state negative electrode film 2.

(C) Separator Membrane

The separator membrane is formed by mixing the adhesives such as poly vinylidene fluoride with a ratio of 20-80 wt %, filler with a ratio of (SiO₂, TiO₂, Al₂O₃ . . . ) 20-80% with suitable amounts of solvents (such as acetone and NMP) of two different boiling points by using a ball-grinding machine through 5 hours so as to form a the required separator membrane slurry. The way of film-formation could be fabricated by coating the slurry upon two opposite surfaces of a polyethylene membrane or polypropylene membrane so as to form with the separator membrane. The two solvents of different boiling points serving to solve the polymer adhesive; after the solvent of lower boiling point is evaporated, then the other solvent of high boiling point is retained so that the separator membrane is retained as a gel with good adhesion and plasticity for the combination of solid state positive electrode film and solid state negative electrode film.

(d) Bicell

The positive electrode film, positive electrode film, and separator membrane manufactured by above mentioned ways are cut to a desired size and then they are arranged with the order of positive electrode film, separator membrane, negative electrode film, separator membrane and positive electrode film or the order of negative electrode film, separator membrane, positive electrode film, separator membrane and negative electrode film so as to form a bicell. The bicell is compressed and then is heat-dried.

An electrode adhesive lithium high molecular cell can be made by above way. The process will be described herein.

Manufacturing of separator membrane—poly vinylidene fluoride of 70 wt %, and FOSiO2 of 30 wt % as a filler are mixed with suitable amounts of acetone and NMP (N-Methyl-2-pyrrolidone) through five hours by using a ball grinding machine completely so as to form a required separator membrane slurry. Then the slurry is coated upon the polyethylene membrane or polypropylene membrane as a separator membrane. After the acetone of lower boiling point is evaporated, then the NMP of high boiling point is retained so that the separator membrane is retained as a gel with good adhesion and plasticity.

Manufacturing of positive electrode—carbon black of 6 wt % as conductive carbon, poly vinylidene fluoride of 9 wt % as a polymer adhesive, LiCoO₂ of 85 wt % as active material are mixed with suitable amount of acetone and NMP thoroughly by using a ball-grinding machine completely so as to form a required positive electrode slurry. The slurry is coated upon the current collector (or the slurry is made as a positive electrode film and then is adhered to a net current collector). The acetone and NMP are used to solve the polymer adhesive. After the acetone of lower boiling point is evaporated, then the NMP of high boiling point is retained so that the positive electrode slurry is retained as a gel with good adhesion and plasticity so that it can be adhered to the current collector as a combined structure. The combined structure is then cut to a desired size.

Manufacturing of negative electrode—carbon black of 4 wt % as conductive carbon, poly vinylidene fluoride of 11 wt % as polymer adhesive, and mesocarbon microbeads of 85 wt % as active material are mixed with suitable amount of acetone and NMP thoroughly by using a ball-grinding machine completely so as to form a required negative electrode slurry. Then the slurry is coated upon the current collector (or the slurry is made as a negative electrode film and then is adhered to a net current collector). The acetone and NMP are used to solve the polymer adhesive. After the acetone of lower boiling point is evaporated, then the NMP of high boiling point is retained so that the negative electrode slurry is retained as a gel with good adhesion and plasticity so that it can be adhered to the current collector as a combined structure. The combined structure is then cut to a desired size.

Finally, the positive electrode film, negative electrode film and separator membrane are heat compressed and heat dried through 30 minutes and then they are injected with liquid and is encapsulated.

600 mAH Lithium polymer cell formed by above ways is tested. The result is shown in the following table 1.

TABLE 1

| | Cell fabricated according |
|---|---|
| Item | to the present invention |
| 0.5 C charge and discharge | 98-99 |
| efficiency(%) | |
| Internal resistance (mΩ) | 45-55 |
| Cell lifetime (%) | 95.2 |
| (0.5 C charge and discharge 100 | |
| times) | |
| Rate of self discharge (28 days) (%) | 92.4 |

If the rated capacity of a bicell is 600 mAH, then the 0.5C charge and discharge efficiency means a current of 300 mA is used in charging and discharging.

As shown in table one, from the character commonly used by the cells such as: 0.5C charge and discharge efficiency, internal resistance, cell life time for 0.5C charge and discharge 100 times, as well as 28 days self discharge rate we could see: the present invention could acquire the Lithium polymer cell with excellent cell character, fine workability, low cost as well as environmental-protection.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for manufacturing an electrode adhesive bicell, comprising steps of:
(a) forming a solid state positive electrode film;
(b) forming a solid state negative electrode film;
(c) mixing polymer adhesive, a filler and two solvents of different boiling points as a mixing material; the mixing material being coated upon two opposite surfaces of a porous membrane as a coated object; the coated object being then dried as a separator membrane; the two solvents of different boiling points serving to solving the polymer adhesive; after the solvent of lower boiling point is evaporated, the other solvent of high boiling point is retained so that the separator membrane is retained as a gel with good adhesive and plasticity for the combination of solid state positive electrode film and solid state negative electrode film; and
(d) cutting the solid state positive electrode film, the solid state negative electrode film and the separator membrane to have predetermined sizes according to a desired capacity; the separator membrane being clamped between the solid state positive electrode film and the solid state negative electrode film; then, compressing, heat-blowing and drying the combination structure as a bicell; and
(e) welding a positive electrode conductive stem and a negative electrode conductive stem to the bicell and then welded bicell being placed into an aluminum film bag for vacuuming and then drying for dewater; then electrolyte being filled into the bag for activating the bicell.

2. The method for manufacturing an electrode adhesive bicell as claimed in claim 1, wherein the porous membrane is one of a polyethylene membrane and a polypropylene membrane.

3. The method for manufacturing an electrode adhesive bicell as claimed in claim 1, wherein the solvent of low boiling point has a boiling point between 0° C.˜220° C. and the solvent of high boiling point has a boiling point between 70° C.˜300° C. and the solvent of low boiling point is acetone, and the solvent of high boiling point is NMP(N-Methyl-2-pyrrolidone); and the adhesives of separator membrane is poly vinylidene fluoride with a ratio of 20-80 wt %; the filler of the separator membrane is selected from one of SiO₂, TiO₂, Al₂O₃ with a ratio of 20-80%.

4. The method for manufacturing an electrode adhesive bicell as claimed in claim 1, wherein the bicell is arranged with an order of positive electrode film, separator membrane, negative electrode film, separator membrane and positive electrode film, or an order of negative electrode film, separator membrane, positive electrode film, separator membrane and negative electrode film so as to form a bicell.

5. A method for manufacturing an electrode adhesive bicell comprising the steps of:
(a) forming a solid state positive electrode film including the step of mixing a polymer adhesive, two solvents of different boiling points, a conductive carbon, an active material into a positive electrode slurry material; the positive electrode slurry material being coated upon two opposite sides of a current collector as a combination structure; after drying, the combination structure is formed as a solid state positive electrode film; the two solvents of different boiling points serving to solve the polymer adhesive; wherein after the solvent of lower boiling point is evaporated, then the other solvent of high boiling point is retained so that the solid state positive electrode film is retained as a gel with good adhesive and plasticity for the combination of solid state positive electrode film and the current collector;
(b) forming a solid state negative electrode film including the step of mixing and then grinding a polymer adhesive, two solvents of different boiling points, a conductive carbon, an active material into a negative electrode slurry material; then the negative electrode film is placed into two opposite sides of a netlike current collector as a combining structure; then the combining structure is dried so as to form a solid state negative electrode film; the two solvents of different boiling points serving to solve the polymer adhesive; wherein after the solvent of lower boiling point is evaporated, then the other solvent of high boiling point is retained so that the solid state negative electrode film is retained as a gel with good adhesion and plasticity for the combination of the solid state negative electrode film and the current collector;
(c) forming a separator membrane including the step of mixing a polymer adhesive, two solvents of different boiling points, a conductive carbon, an active material into slurry material; the slurry material being coated upon two opposite sides of a porous thin film as a combination structure; after drying, the combination structure is formed as a separator membrane; the two solvents of different boiling points serving to solve the polymer adhesive; wherein after the solvent of lower boiling point is evaporated, then the other solvent of high boiling point is retained so that the separator membrane is retained as a gel with good adhesive and plasticity for the combination of the solid state positive electrode film and the solid state negative electrode film;
(d) cutting the solid state positive electrode film, the solid state negative electrode film and the separator membrane into predetermined sizes; then they are compressed and hot dried; and
(e) welding a positive electrode conductive stem and a negative electrode conductive stem to the bicell and then welded bicell being placed into an aluminum film bag for vacuuming and then drying for dewater; then electrolyte is filled into the bag for activating the bicell.

6. The method for manufacturing an electrode adhesive bicell as claimed in claim 5, wherein the porous membrane is one of a polyethylene membrane and a polypropylene membrane.

7. The method for manufacturing an electrode adhesive bicell as claimed in claim 5, wherein the solvent of low boiling point has a boiling point between 0° C.˜220° C. and the solvent of high boiling point has a boiling point between 70° C.˜300° C.; and the solvent of low boiling point is acetone, and the solvent of high boiling point is NMP(N-Methyl-2-pyrrolidone).

8. The method for manufacturing an electrode adhesive bicell as claimed in claim 5, wherein in solid state positive electrode film, the polymer adhesive contains poly vinylidene fluoride with a ratio of about 2˜15 wt %; the conductive carbon is carbon black with a ratio of about 2˜10 wt %; the active material is one of LiCoO2, LiNiO2, LiMn2O4, and LiNixCo1-xO2 with a ratio of about 75˜96 wt %.

9. The method for manufacturing an electrode adhesive bicell as claimed in claim 5, wherein in solid state negative electrode film, the polymer adhesive contains poly vinylidene fluoride with a ratio of about 2˜15 wt %; the conductive carbon is carbon black with a ratio of about 2˜10 wt %; the active substance is one of the mesocarbon microbeads, nature graphite as well as its refinement, other carbon material, tin compound, silicide and has a content of 75-96 wt %.

10. The method for manufacturing an electrode adhesive bicell as claimed in claim 5, wherein in the separator membrane, the adhesives are poly vinylidene fluoride with a ratio of 20-80wt %, and the filler are one of SiO₂, TiO₂, Al₂O₃ with a ratio of 20-80% with suitable amounts of acetone and NMP which have different boiling points.

11. The method for manufacturing an electrode adhesive bicell as claimed in claim 5, wherein the bicell is arranged with an order of positive electrode film, separator membrane, negative electrode film, separator membrane and positive electrode film, or an order of negative electrode film, separator membrane, positive electrode film, separator membrane and negative electrode film so as to form a bicell.

12. The method for manufacturing an electrode adhesive bicell as claimed in claim 5, wherein the current collector of the solid state positive electrode film is aluminum film, and the current collector of the solid state negative electrode film is copper film.

13. A method for manufacturing an electrode adhesive bicell comprising the steps of:
(a) forming a solid state positive electrode film including the step of mixing a polymer adhesive, two solvents of different boiling points, a conductive carbon, an active material into a positive electrode slurry material; the positive electrode slurry material being coated upon a substrate as a combination structure; after dried, the combination structure is as a positive electrode film which are placed at two sides of a netlike current collector; after hot compressing, it being formed as a solid state positive electrode film; the two solvents of different boiling points serving to solve the polymer adhesive; wherein after the solvent of lower boiling point is evaporated, then the other solvent of high boiling point is retained so that the solid state positive electrode film is retained as a gel;
(b) forming a solid state negative electrode film including the step of mixing a polymer adhesive, two solvents of different boiling points, a conductive carbon, an active material into a negative electrode slurry material; the negative electrode slurry material being coated upon a substrate as a combination structure; after dried, the combination structure is as a negative electrode film which are placed at two sides of a netlike current collector; after hot compressing, it being formed as a solid state negative electrode film; the two solvents of different boiling points serving to solve the polymer adhesive; wherein after the solvent of lower boiling point is evaporated, then the other solvent of high boiling point is retained so that the solid state negative electrode film is retained as a gel;
(c) forming a separator membrane including the step of mixing a polymer adhesive, two solvents of different boiling points, a conductive carbon, an active material into slurry material; the slurry material being coated upon two opposite sides of a porous thin film as a combination structure; after drying, the combination structure is formed as a separator membrane; the two solvents of different boiling points serving to solve the polymer adhesive; wherein after the solvent of lower boiling point is evaporated, then the other solvent of high boiling point is retained so that the separator membrane is retained as a gel with good adhesion and plasticity for the combination of the solid state positive electrode film and the solid state negative electrode film;
(d) cutting the solid state positive electrode film, the solid state negative electrode film and the separator membrane into predetermined sizes; then they are compressed and hot dried; and
(e) welding a positive electrode conductive stem and a negative electrode conductive stem to the bicell and then welded bicell being placed into an aluminum film bag for vacuuming and then drying for dewater; then electrolyte is filled into the bag for activating the bicell.

14. The method for manufacturing an electrode adhesive bicell as claimed in claim 13, wherein the porous membrane is one of a polyethylene membrane and a polypropylene membrane.

15. The method for manufacturing an electrode adhesive bicell as claimed in claim 13, wherein the solvent of low boiling point has a boiling point between 0° C.˜220° C. and the solvent of high boiling point has a boiling point between 70° C.˜300° C.; and the solvent of low boiling point is acetone, and the solvent of high boiling point is NMP(N-Methyl-2-pyrrolidone).

16. The method for manufacturing an electrode adhesive bicell as claimed in claim 13, wherein in solid state positive electrode film, the polymer adhesive contains poly vinylidene fluoride with a ratio of about 2˜15 wt %; the conductive carbon is carbon black with a ratio of about 2˜10 wt %; the active material is one of LiCoO2, LiNiO2, LiMn2O4, LiNixCo1-xO2 with a ratio of about 75˜96 wt %.

17. The method for manufacturing an electrode adhesive bicell as claimed in claim 1, wherein in solid state negative electrode film, the polymer adhesive contains poly vinylidene fluoride with a ratio of about 2˜15 wt %; the conductive carbon is carbon black with a ratio of about 2˜10 wt %; the active substance is one of the mesocarbon microbeads, nature graphite as well as its refinement, other carbon material, tin compound, silicide and has a content of 75-96 wt %.

18. The method for manufacturing an electrode adhesive bicell as claimed in claim 13, wherein in the separator membrane, the adhesives are poly vinylidene fluoride with a ratio of 20-80 wt %, the filler are one of SiO₂, TiO₂, Al₂O₃ with a ratio of 0-80% with suitable amounts of acetone and NMP which have different boiling points.

19. The method for manufacturing an electrode adhesive bicell as claimed in claim 13, wherein the bicell is arranged with an order of positive electrode film, separator membrane, negative electrode film, separator membrane and positive electrode film, or an order of negative electrode film, separator membrane, positive electrode film, separator membrane and negative electrode film so as to form a bicell.

20. The method for manufacturing an electrode adhesive bicell as claimed in claim 13, wherein the substrates in the solid state positive electrode film and solid state negative electrode film are PET; and the current collector of the solid state positive electrode film is aluminum film, and the current collector of the solid state negative electrode film is copper film.
